(19) United States
(12) Patent Application Publication
(10) Pub. No.: US 2025/0147262 A1
(43) Pub. Date: May 8, 2025

(54) FEEDTHROUGH AND METHOD FOR MANUFACTURING FEEDTHROUGH

(71) Applicant: NEC Corporation, Tokyo (JP)

(72) Inventor: Toshihide NAGASAWA, Tokyo (JP)

(73) Assignee: NEC Corporation, Tokyo (JP)

(21) Appl. No.: 18/923,864

(22) Filed: Oct. 23, 2024

(30) Foreign Application Priority Data
Nov. 7, 2023 (JP) 2023-189907

(51) Int. Cl. G02B 6/44

(52) U.S. Cl. CPC G02B 6/44775; G02B 6/4479

(57) ABSTRACT

To provide a feedthrough and a method for manufacturing the feedthrough that make it possible to achieve high reliability and reduce optical loss of an optical fiber. The feedthrough includes: a sleeve including an upper sleeve portion, a sleeve central portion, and a sleeve lower portion; a guide fitted to at least an inner peripheral surface of the sleeve central portion; an optical fiber inserted through a through hole formed in the sleeve; and a sealing material being formed between the sleeve upper portion and the guide and hermetically sealing a part of the optical fiber to a sealing groove communicating with the through hole. In the sleeve, a thermal conductivity of the sleeve lower portion is lower than a thermal conductivity of the sleeve upper portion.

### INCORPORATION BY REFERENCE

This application is based upon and claims the benefit of priority from Japanese patent application No. 2023-189907, filed on Nov. 7, 2023, the disclosure of which is incorporated herein in its entirety by reference.

### TECHNICAL FIELD

The present disclosure relates to a feedthrough and a method for manufacturing the feedthrough.

### BACKGROUND ART

For example, a submarine cable using an optical fiber as a transmission line is installed on the sea floor at a depth of several thousand meters together with a submarine repeater, and therefore is subjected to high water pressure (for example, water pressure equivalent to a water depth of 8,000 m). Therefore, a feedthrough being a connection portion for introducing the submarine cable into the submarine repeater is required to have reliability such as pressure resistance, water tightness, and airtightness, and low optical loss of the optical fiber.

Such a feedthrough has a structure in which a part of an optical fiber inserted between a sleeve and a guide fitted to an inner peripheral surface of the sleeve is hermetically sealed in a sealing groove by a sealing material such as solder filled in the sealing groove in the feedthrough.

Japanese Unexamined Patent Application Publication No. 2003-75653 discloses that, in an airtight sealing method of an optical fiber for hermetically sealing a plurality of optical fibers to be introduced into a pressure-resistant housing by solder filled in a solder sealing portion in a fiber feedthrough, the solder filled in the solder sealing portion is melted by a heating means (heating coil), and the molten solder is sequentially solidified from a sealing bottom side of the solder sealing portion to a sealing upper side of the solder sealing portion.

Patent Literature 1: Japanese Unexamined Patent Application Publication No. 2003-75653

### SUMMARY

In the technique described in Japanese Unexamined Patent Application Publication No.2003-75653, by cooling a range from a sleeve central portion to a sleeve upper portion of the sleeve (metal sleeve) by water cooling or the like, the molten sealing material (solder) is solidified from the sealing bottom side of the solder sealing portion beings a sealing groove to the sealing upper side of the solder sealing portion sequentially. Thus, in the technique described in Japanese Unexamined Patent Application Publication No.2003-75653, since it is not assumed to cool a sleeve lower portion of the sleeve, particularly when heating time by the heating means is long or when a heating temperature by the heating means is high, the molten sealing material is likely to flow downward from the sealing groove.

When the molten sealing material flows out from the sealing groove downward more than necessary, in the feedthrough after the sealing material solidifies, a filling amount of the sealing material filled in the sealing groove becomes insufficient, or filling of the sealing material becomes uneven, and as a result, voids may be generated inside the sealing material. In this case, there is a problem that reliability such as pressure resistance, water tightness, and airtightness of the feedthrough is deteriorated, and optical loss is increased due to occurrence of microbend in the optical fiber. A decrease in the reliability of the feedthrough and an increase in the optical loss of the optical fiber lead to a decrease in reliability of the submarine repeater connected to the submarine cable by the feedthrough.

In view of the above-described problems, an example object of the present disclosure is to provide a feedthrough and a method for manufacturing the feedthrough that make it possible to achieve high reliability and reduce optical loss of an optical fiber.

In a first example aspect of the present disclosure, a feedthrough includes a sleeve including a sleeve upper portion, a sleeve central portion, and a sleeve lower portion, a guide fitted to at least an inner peripheral surface of the sleeve central portion, an optical fiber inserted into a through hole formed in the sleeve, and a sealing material being formed between the sleeve upper portion and the guide and hermetically sealing a part of the optical fiber to a sealing groove communicating with the through hole. In the sleeve, a thermal conductivity of the sleeve lower portion is lower than a thermal conductivity of the sleeve upper portion.

In a second example aspect of the present disclosure, a method for manufacturing a feedthrough includes, by means of a heat-melted and solidified sealing material, hermetically sealing a part of an optical fiber inserted into a through hole formed in a sleeve including a sleeve upper portion, a sleeve central portion, and a sleeve lower portion to a sealing groove being formed between the sleeve upper portion and a guide fitted to at least an inner peripheral surface of the sleeve central portion and communicating with the through hole. In the sleeve, a thermal conductivity of the sleeve lower portion is lower than a thermal conductivity of the sleeve upper portion.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating a feedthrough according to the present disclosure;

FIG. 2 is a diagram illustrating a feedthrough according to a comparative example.

### EXAMPLE EMBODIMENT

Hereinafter, an example embodiment of the present disclosure is described with reference to the drawings. However, the present disclosure is not limited to the following example embodiments. Further, for clarity of explanation, the following description and the drawings are simplified as appropriate. Furthermore, in the following description, the same or equivalent elements are denoted by the same reference numerals, and redundant description thereof will be omitted.

### First Example Embodiment

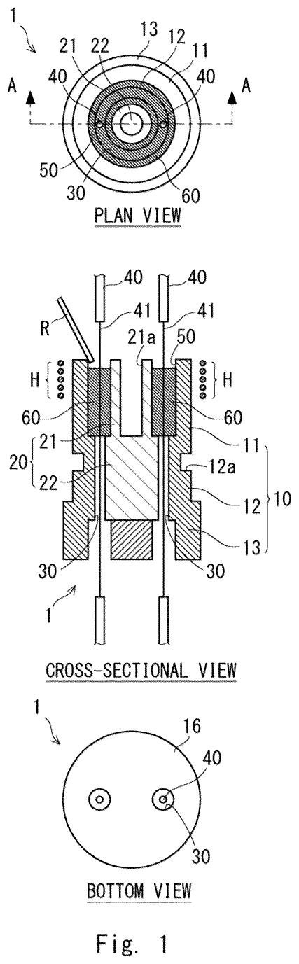

First, a configuration example of a feedthrough 1 is described with reference to FIG. 1. FIG. 1 is a diagram illustrating a feedthrough according to the present disclosure. On the upper side of FIG. 1, a plan view of the feedthrough 1 is illustrated. In the center of FIG. 1, an A-A cross-sectional view of the feedthrough 1 is illustrated. On the lower side of FIG. 1, a bottom view of the feedthrough 1 is illustrated. In the plan view of FIG. 1, a sealing material 60 filled in a sealing groove 50 is illustrated by hatching, but this hatching does not illustrate a cross section of the sealing material 60.

This feedthrough 1 is, for example, a connection portion for introducing a submarine cable into a submarine repeater. Hereinafter, a description will be made in specific terms of the feedthrough 1 connecting the submarine cable using an optical fiber 40 as a transmission line to the submarine repeater, but the feedthrough 1 according to the present disclosure can be applied not only to the submarine repeater but also to other electronic devices.

As illustrated in FIG. 1, the feedthrough 1 has a sleeve 10 including a sleeve upper portion 11, a sleeve central portion 12, and a sleeve lower portion 13, and a guide 20 fitted to at least an inner peripheral surface of the sleeve central portion 12. Further, the feedthrough 1 has the optical fiber 40 inserted through a through hole 30 formed in the sleeve 10. Further, the feedthrough 1 has the sealing material 60 formed between the sleeve upper portion 11 and the guide 20 and hermetically sealing a part of the optical fiber 40 in the sealing groove 50 communicating with the through hole 30. In the sleeve 10, the thermal conductivity of the sleeve lower portion 13 is lower than the thermal conductivity of the sleeve upper portion 11.

According to such a configuration, in a sealing step to be described later when manufacturing the feedthrough 1, the molten sealing material 60 is suppressed from flowing out of the sealing groove 50 more than necessary downward, it is possible to suitably fill the sealing material 60 for hermetically sealing a part of the optical fiber 40 to the sealing groove 50.

Each component of the feedthrough 1 is described in detail. The sleeve 10 is a bottomed cylindrical member made of metal and extending in the up-down direction. The sleeve 10 includes the sleeve upper portion 11 formed in a substantially cylindrical shape, the sleeve central portion 12 formed in a substantially cylindrical shape, and the sleeve lower portion 13 formed in a substantially cylindrical shape. The sleeve upper portion 11, the sleeve central portion 12, and the sleeve lower portion 13 are arranged in this order from above in the up-down direction, and are integrally formed.

The sleeve upper portion 11 forms a cylindrical portion of the sleeve 10 together with the sleeve central portion 12. The sleeve central portion 12 has a thickness larger than the thickness of the sleeve upper portion 11 in such a way as to expand radially inward of the sleeve 10. Accordingly, the sleeve central portion 12 has an inner diameter that is smaller than the inner diameter of the sleeve upper portion 11 and has an outer diameter that is substantially the same as the outer diameter of the sleeve upper portion 11. Further, a heat adjustment groove 12a recessed from the outer peripheral surface toward radially inward of the sleeve 10 is formed in the sleeve central portion 12. The heat adjustment groove 12a extends in the circumferential direction. The heat adjustment groove 12a has a function of adjusting the relative heat capacity of the sleeve central portion 12 and a guide lower portion 22 by reducing the heat capacity of the sleeve central portion 12.

The sleeve lower portion 13 constitutes the bottom of the sleeve 10. The sleeve lower portion 13 has a thickness larger than the thickness of the sleeve upper portion 11 in such a way as to expand radially outward of the sleeve 10. Therefore, the sleeve lower portion 13 has an inner diameter substantially the same as the inner diameter of the sleeve upper portion 11, and has an outer diameter larger than the outer diameter of the sleeve upper portion 11. The sleeve lower portion 13 has an increased heat dissipation area as compared with the sleeve upper portion 11, and thus has an increased heat capacity.

The guide 20 is a metal rod-shaped member extending in the up-down direction. The guide 20 includes a guide upper portion 21 and the guide lower portion 22. The guide upper portion 21 and the guide lower portion 22 are arranged in this order from above in the up-down direction, and are integrally formed. A heat adjustment groove 21a recessed from the upper end surface toward the lower side is formed in the guide upper portion 21. The heat adjustment groove 21a extends in the up-down direction along the sealing groove 50. The heat adjustment groove 21a has a function of adjusting the relative heat capacity of the sleeve upper portion 11 and the guide upper portion 21 by reducing the heat capacity of the guide upper portion 21.

The guide lower portion 22 has an outer diameter slightly smaller than the inner diameter of the sleeve central portion 12, and is fitted to the inner peripheral surface of the sleeve central portion 12. The guide lower portion 22 has an outer diameter larger than the outer diameter of the guide upper portion 21. In the guide 20 fitted to the inner peripheral surface of the sleeve central portion 12, the guide lower portion 22 abuts against the sleeve lower portion 13. This restricts downward movement of the guide 20 within the sleeve 10, so that at least the feedthrough 1 after the sealing step does not require a fixing member such as a nut for fixing the guide 20 within the sleeve 10.

The feedthrough 1 includes at least one optical fiber 40. For example, the feedthrough 1 includes a plurality of the optical fibers 40. The optical fiber 40 is inserted into the through hole 30 that penetrates the feedthrough 1 in the up-down direction. The feedthrough 1 illustrated in FIG. 1 is inserted into the through hole 30 so that the two optical fibers 40 are arranged symmetrically in the radial direction with respect to the central axis of the feedthrough 1 extending in the up-down direction. The optical fiber 40 has a covering portion 41 in which a metal coating is applied to a surface of a resin primary coating exposed by removing a part of a resin protective coating.

The sealing groove 50 filled with the sealing material 60 is a groove extending in the up-down direction defined by the inner peripheral surface of the sleeve upper portion 11 and the outer peripheral surface of the guide upper portion 21. An upper end of the sealing groove 50 is open and communicates with the outside, and a lower end thereof communicates with the through hole 30.

As the sealing material 60, a low-melting-point metal such as solder can be used. The sealing material 60 is filled in the sealing groove 50 by being heat-melted and solidified. The sealing material 60 can be filled in the sealing groove 50 by heat-melting the sealing material by contacting a solder rod R inserted into the sealing groove 50 from the opening of the sealing groove 50 with the sleeve 10 (more specifically, the upper end surface of the sleeve upper portion 11), and then solidifying the sealing material. However, the method for filling the sealing material 60 into the sealing groove 50 is not limited to this. For example, the sealing material 60 be may filled into the sealing groove 50 by heat-melting and solidifying the molten solder poured into the sealing groove 50 from the opening of the sealing groove 50. The sealing material 60 can be heat-melted by a heating means H such as a heating coil provided outside the sleeve 10. When the sealing material 60 is solidified, the sealing material 60 may be cooled and solidified by an appropriate cooling means.

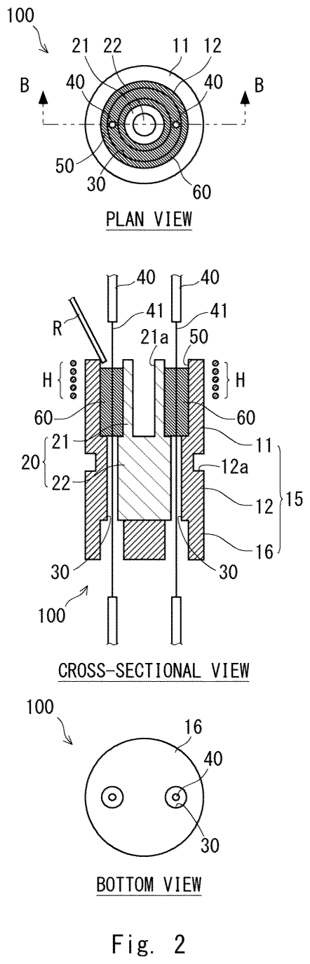

Here, FIG. 2 is a diagram illustrating a feedthrough according to a comparative example. On the upper side of FIG. 2, a plan view of the feedthrough 100 is illustrated. In the center of FIG. 2, a B-B cross-sectional view of the feedthrough 100 is illustrated. On the lower side of FIG. 2, a bottom view of the feedthrough 100 is illustrated. Note that, as in the case of FIG. 1, in the plan view of FIG. 2, the sealing material 60 filled in the sealing groove 50 is illustrated by hatching, but this hatching does not illustrate a cross section of the sealing material 60.

As illustrated in FIG. 2, the feedthrough 100 according to the comparative example has the same components as the feedthrough 1 except that a sleeve 15 is provided instead of the sleeve 10. Therefore, the feedthrough 100 is described with a focus on the difference from the feedthrough 1.

The feedthrough 100 includes the sleeve 15 including the sleeve upper portion 11, the sleeve central portion 12, and a sleeve lower portion 16, and the guide 20 fitted to the inner peripheral surface of the sleeve central portion 12. Further, the feedthrough 100 has the optical fiber 40 inserted through the through hole 30 formed in the sleeve 15. Further, the feedthrough 100 has the sealing material 60 formed between the sleeve upper portion 11 and the guide 20 and hermetically sealing a part of the optical fiber 40 in the sealing groove 50 communicating with the through hole 30.

Unlike the sleeve lower portion 13, the sleeve lower portion 16 has a thickness substantially equal to the thickness of the sleeve upper portion 11. Accordingly, the sleeve lower portion 16 has an inner diameter substantially the same as the inner diameter of the sleeve upper portion 11, and has an outer diameter substantially the same as the outer diameter of the sleeve upper portion 11. In the sleeve 15, the thermal conductivity of the sleeve lower portion 16 is equivalent to the thermal conductivity of the sleeve upper portion 11.

The method for manufacturing the feedthrough 1, 100 includes a sealing step of hermetically sealing a part of the optical fiber 40 to the sealing groove 50 by means of the sealing material 60 which is heat-melted and solidified. In this sealing step, the sealing material 60 is melted by heating the sleeve 10, 15 by the heating means H so that the temperature of the sleeve 10, 15 (in particular, the sleeve upper portion 11) becomes equal to or higher than the melting point temperature of the sealing material 60. However, when the sleeve 10, 15 is heated by the heating means H, the sealing groove 50 serves as heat insulation, and thus the heat conduction is deteriorated. Therefore, in order to heat the temperature of, particularly the inside of the sealing groove 50 in the radial direction (the guide 20 side) to a temperature equal to or higher than the melting point of the sealing material 60, it is necessary to apply excessive heat to the sleeve 10, 15 by the heating means H.

Here, when at least one of the sealing groove 50 and the through hole 30 is overheated, the primary coating in the covering portion 41 is thermally deformed to increase the light loss, and the pressure resistance, the water tightness, and the airtightness of the feedthrough 1, 100 may be lowered. Further, when a temperature gradient from the outer side in the radial direction (sleeve 10 side or sleeve 15 side) in the sealing groove 50 to the inner side is generated, when the sealing material 60 solidifies, the inside of the sealing material 60 is distorted, a microbend is generated in the optical fiber 40, and therefore the optical loss can be increased.

In the feedthrough 1, 100, since the heat adjustment groove 21a is provided in the guide upper portion 21, the amount of heating by the heating means H can be reduced, and therefore, overheating of the sealing groove 50 (particularly, the outer side in the radial direction of the sealing groove 50) together with the sleeve upper portion 11 is suppressed. As a result, deformation of the primary coating in the covering portion 41 can be suppressed.

Further, in the feedthrough 1, 100, since the heat adjustment groove 21a is provided in the guide upper portion 21, it is possible to reduce the temperature gradient from the outer side to the inner side in the radial direction of the sealing groove 50, and when the sealing material 60 is solidified, a strain is generated in the interior of the sealing material 60, thus the occurrence of microbend in the optical fiber 40 is suppressed. As a result, an increase in optical loss of the optical fiber 40 is suppressed.

Further, in the feedthrough 1, 100, since the heat adjustment groove 12a is provided in the sleeve central portion 12, the amount of heating by the heating means H can be reduced, and therefore, overheating of the through hole 30 between the sleeve central portion 12 and the guide lower portion 22 together with the sleeve central portion 12 is suppressed. As a result, thermal deformation of the primary coating in the covering portion 41 is suppressed.

However, particularly when the heating time by the heating means H is long or the heating temperature by the heating means H is high, in the sealing step in manufacturing the feedthrough 100, the molten sealing material 60 easily flows downward from the sealing groove 50. When the sealing material 60 melted in this way flows out of the sealing groove 50 downward more than necessary, in the feedthrough 100 after the sealing material 60 is solidified, the filling amount of the sealing material 60 filled in the sealing groove 50 may become insufficient. Further, in the feedthrough 100 after the sealing material 60 is solidified, the filling of the sealing material 60 becomes uneven, so that a void may be generated inside the sealing material 60. In this case, there is a problem that reliability such as pressure resistance, water tightness, and airtightness of the feedthrough 100 is reduced, and optical loss is increased due to occurrence of microbend in the optical fiber 40.

Therefore, the method for manufacturing the feedthrough 1 includes a sealing step of hermetically sealing, by means of the heat-melted and solidified sealing material 60, a part of the optical fiber 40 inserted into the through hole 30 formed in the sleeve 10 to the sealing groove 50 formed between the sleeve upper portion 11 and the guide 20 fitted to at least the inner peripheral surface of the sleeve central portion 12 and communicating with the through hole 30. In the sleeve 10, the thermal conductivity of the sleeve lower portion 13 is lower than the thermal conductivity of the sleeve upper portion 11. By such a manufacturing method, it is possible to obtain the feedthrough 1 in which the sealing material 60 for hermetically sealing a part of the optical fiber 40 in the sealing groove 50 is suitably filled.

In the sealing step in manufacturing the feedthrough 1, when the sleeve 10 is heated by the heating means H, the heat dissipation effect of the sleeve lower portion 13 is high, so that the temperature of the through hole 30 in the sleeve lower portion 13 can be lowered. Therefore, in this sealing step, even if the molten sealing material 60 flows downward from the sealing groove 50, the sealing material 60 solidifies and remains in a range close to the sleeve upper portion 11 of the through hole 30. Therefore, the molten sealing material 60 is prevented from flowing downward from the sealing groove 50 more than necessary. As a result, the sealing material 60 can be uniformly filled in the sealing groove 50 with a sufficient filling amount. Therefore, it is possible to suppress an increase in optical loss due to a decrease in reliability such as pressure resistance, water tightness, and airtightness of the feedthrough 1, and the occurrence of microbend in the optical fiber 40.

Therefore, according to the present example embodiment, it is possible to provide the feedthrough 1 and the method for manufacturing the feedthrough 1 that make it possible to achieve high reliability and reduce the optical loss of the optical fiber 40.

### Other Example Embodiment

In the first example embodiment described above, the difference in thermal conductivity is caused between the sleeve upper portion 11 and the sleeve lower portion 13 by making the thickness of the sleeve lower portion 13 larger than the thickness of the sleeve upper portion 11. However, other configurations may be employed as long as the thermal conductivity of the sleeve lower portion 13 can be made lower than the thermal conductivity of the sleeve upper portion 11.

For example, in the feedthrough 1, a heat dissipation member may be attached to an outer peripheral surface of the sleeve lower portion 13. The heat dissipation member is a member having higher thermal conductivity than the sleeve 10. As the heat dissipation member, for example, a heat dissipation sheet such as a cool sheet or a heat dissipation body such as a heat sink can be used. These heat dissipation members may be attached to be in close contact with the outer peripheral surface of the sleeve lower portion 13. In the case of the sleeve lower portion 13 having an outer peripheral surface and an inner peripheral surface, a heat dissipation member may be attached to at least one of the inner peripheral surface and the outer peripheral surface of the sleeve lower portion 13.

The heat dissipation members may be used alone or in combination. In a case where these heat dissipation members are used in combination, for example, the heat dissipation member may include a heat sink attached to the outer peripheral surface of the sleeve lower portion 13 as a heat dissipation body, and may include a cool sheet interposed between the sleeve lower portion 13 and the heat dissipation body as a heat dissipation sheet. By attaching a substantially cylindrical heat sink to the outer peripheral surface of the sleeve lower portion 13 and interposing a cool sheet having high adhesion between the sleeve lower portion 13 and the heat sink, it is possible to further enhance the heat dissipation effect.

Further, the sleeve lower portion 13 may have a fin shape. When the sleeve lower portion 13 has a fin shape, the heat dissipation area of the sleeve lower portion 13 increases, so that the heat dissipation effect can be enhanced.

In other example embodiments described above, the thickness of the sleeve lower portion 13 need not be larger than the thickness of the sleeve upper portion 11, but the thickness of the sleeve lower portion 13 may be larger than the thickness of the sleeve upper portion 11 as necessary.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes. Some or all of the elements (e.g., configurations and functions) specified in Supplementary Notes 2 to 7, which are dependent on Supplementary Note 1, may be dependent on Supplementary Note 8 in dependency similar to that of Supplementary Notes 2 to 7 on Supplementary Note 1.

### Supplementary Note 1

A feedthrough comprising:
a sleeve including a sleeve upper portion, a sleeve central portion, and
a sleeve lower portion;
a guide fitted to at least an inner peripheral surface of the sleeve central portion;
an optical fiber inserted through a through hole formed in the sleeve;
and a sealing material being formed between the sleeve upper portion and the guide and hermetically sealing a part of the optical fiber in a sealing groove communicating with the through hole,
   Wherein, in the sleeve, a thermal conductivity of the sleeve lower portion is lower than a thermal conductivity of the sleeve upper portion.

### Supplementary Note 2

The feedthrough according to supplementary note 1, wherein the sleeve lower portion has a thickness greater than a thickness of the sleeve upper portion in such a way as to expand radially outward.

### Supplementary Note 3

The feedthrough according to supplementary note 1 or 2, wherein a heat dissipation member is attached to at least one of an inner peripheral surface and an outer peripheral surface of the sleeve lower portion.

### Supplementary Note 4

The feedthrough according to any one of supplementary notes 1 to 3, wherein the sleeve lower portion has a fin shape.

### Supplementary Note 5

The feedthrough according to any one of supplementary notes 1 to 4, wherein a heat adjustment groove recessed from an outer peripheral surface toward an inner side in a radial direction is formed in the sleeve central portion.

### Supplementary Note 6

The feedthrough according to any one of supplementary notes 1 to 5, wherein a heat adjustment groove recessed from an upper end surface toward a lower side is formed in a guide upper portion of the guide.

### Supplementary Note 7

The feedthrough according to any one of supplementary notes 1 to 6, wherein a submarine cable using the optical fiber as a transmission line is connected to a submarine repeater.

### Supplementary Note 8

A method for manufacturing a feedthrough, comprising, by means of a heat-melted and solidified sealing material, hermetically sealing a part of an optical fiber inserted into a through hole formed in a sleeve including a sleeve upper portion, a sleeve central portion, and a sleeve lower portion to a sealing groove being formed between the sleeve upper portion and a guide fitted to at least an inner peripheral surface of the sleeve central portion and communicating with the through hole,
wherein, in the sleeve, a thermal conductivity of the sleeve lower portion is lower than a thermal conductivity of the sleeve upper portion.

According to the present disclosure, it is possible to provide a feedthrough and a method for manufacturing the feedthrough that make it possible to achieve high reliability and reduce optical loss of an optical fiber.

What is claimed is:

1. A feedthrough comprising:
a sleeve including a sleeve upper portion, a sleeve central portion, and a sleeve lower portion;
a guide fitted to at least an inner peripheral surface of the sleeve central portion;
an optical fiber inserted through a through hole formed in the sleeve;
and a sealing material being formed between the sleeve upper portion and the guide and hermetically sealing a part of the optical fiber in a sealing groove communicating with the through hole,
Wherein, in the sleeve, a thermal conductivity of the sleeve lower portion is lower than a thermal conductivity of the sleeve upper portion.

2. The feedthrough according to claim 1, wherein the sleeve lower portion has a thickness greater than a thickness of the sleeve upper portion in such a way as to expand radially outward.

3. The feedthrough according to claim 1, wherein a heat dissipation member is attached to at least one of an inner peripheral surface and an outer peripheral surface of the sleeve lower portion.

4. The feedthrough according to claim 1, wherein the sleeve lower portion has a fin shape.

5. The feedthrough according to claim 1, wherein a heat adjustment groove recessed from an outer peripheral surface toward an inner side in a radial direction is formed in the sleeve central portion.

6. The feedthrough according to claim 1, wherein a heat adjustment groove recessed from an upper end surface toward a lower side is formed in a guide upper portion of the guide.

7. The feedthrough according to claim 1, wherein a submarine cable using the optical fiber as a transmission line is connected to a submarine repeater.

8. A method for manufacturing a feedthrough, comprising,
by means of a heat-melted and solidified sealing material, hermetically sealing a part of an optical fiber inserted into a through hole formed in a sleeve including a sleeve upper portion, a sleeve central portion, and a sleeve lower portion to a sealing groove being formed between the sleeve upper portion and a guide fitted to at least an inner peripheral surface of the sleeve central portion and communicating with the through hole,
wherein, in the sleeve, a thermal conductivity of the sleeve lower portion is lower than a thermal conductivity of the sleeve upper portion.
